(19) United States
(12) Patent Application Publication
(10) Pub. No.: US 2013/0166671 A1
(43) Pub. Date: Jun. 27, 2013

(54) NODE CONTROLLER AND METHOD OF CONTROLLING NODE CONTROLLER

(71) Applicant: FUJITSU LIMITED, KAWASAKI-SHI (JP)

(72) Inventors: KENTA SATO, KAWASAKI (JP); TOSHIKAZU UEKI, YOKOHAMA (JP); TAKASHI YAMAMOTO, KAWASAKI (JP)

(73) Assignee: FUJITSU LIMITED, KAWASAKI-SHI (JP)

(21) Appl. No.: 13/776,828

(22) Filed: Feb. 26, 2013

Related U.S. Application Data
(63) Continuation of application No. PCT/JP2010/065056, filed on Sep. 2, 2010.

(51) Int. Cl. G06F 13/16; H04L 12/56

(52) U.S. Cl. CPC G06F 13/1668
USPC 709/214

(57) ABSTRACT

A node controller includes: a reception processor configured to receive a packet and to generate a read request or write data and a write request for requesting to write the write data, according to a destination and a type of the packet; a collected data processor configured to collect the received packet, to generate collected data according to the collected packet, and to generate a collected data write request for requesting to write the collected data; a switch configured to output the write data and the write request received from the reception processor or output the collected data and the collected data write request received from the collected data processor; and a memory controller configured to write the write data to a memory and to write the collected data to the memory in accordance with the collected data write request received from the switch.

### CROSS-REFERENCE TO RELATED APPLICATION

This application is a continuation application of International Application PCT/JP2010/065056 filed on Sep. 2, 2010 and designated the U.S., the entire contents of which are incorporated herein by reference.

### FIELD

The embodiments described herein are related to a node controller, a method of controlling a node controller, and a computer system.

### BACKGROUND

Some computer systems are configured with a plurality of nodes each of which is provided with one node controller and a plurality of CPUs (Central Processing Units). In one node, data is transmitted and received between a node controller and a CPU via a transmission path that connects the node controller to the CPU.

Detecting a waveform of a signal transmitted via a transmission path is effective in analyzing of an operation of or the cause of a failure of the computer system. Accordingly, various means for measuring a signal on an IC-implemented substrate have been proposed.

As an example, a method and apparatus has been proposed for testing wirings in a circuit board mounted with an integrated circuit, and a circuit having the function of executing a time domain reflectivity test is incorporated therein, by sending a test transition signal generated by the integrated circuit (IC) mounted thereon to the wiring and capturing the reflection of the test transition signal.

The following have also been proposed: measuring the frequency characteristics of the transmission line between substrates; measuring a first signal waveform in a time domain observed from a signal transmission point and a second signal waveform in a time domain of signals, reaching a signal reception point through the transmission line between substrates from the signal transmission point; performing convolution calculations on an impulse response obtained from the measured frequency characteristics and the first signal waveform; detecting delay on the transmission line between substrates based on the convolution operation result; detecting delay on the substrate, based on the convolution operation result and the second signal waveform; adding the delay time on the transmission line between the substrates to that on the substrates.

These technologies are described in, for example, Japanese Laid-open Patent Publication No. 2006-145527 and Japanese Laid-open Patent Publication No. 2006-208060.

Transmission characteristics of LSIs such as a node controller and a CPU are different for each LSI. Accordingly, a probe is put on a transmission path connected to a node controller or a CPU so as to observe a transmitted waveform, i.e., a transmission characteristic of the LSI, at the transmission path by using a device such as an oscilloscope. However, when a high-speed signal is transmitted, the influence of the probe itself becomes large, so it is difficult to perform the measurement using the probe.

### SUMMARY

According to an aspect of the embodiments, a node controller includes: a reception processor configured to receive a packet and to generate a read request or write data and a write request for requesting to write the write data, according to a destination and a type of the packet; a collected data processor configured to collect the packet received by the reception processor, to generate collected data according to the collected packet, and to generate a collected data write request for requesting to write the collected data; a switch configured to output the write data and the write request received from the reception processor or output the collected data and the collected data write request received from the collected data processor; and a memory controller configured to write the write data to a memory in accordance with the write request received from the switch and to write the collected data to the memory in accordance with the collected data write request received from the switch.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a computer system.

FIG. 2 illustrates an exemplary configuration of a node controller.

FIG. 3 illustrates an exemplary configuration of a collected data processor.

FIG. 4 is a flowchart for illustrating a process for collected data.

FIG. 5 illustrates an exemplary configuration of a switch.

FIG. 6 is a flowchart of an operation of a switching controller.

### DESCRIPTION OF EMBODIMENTS

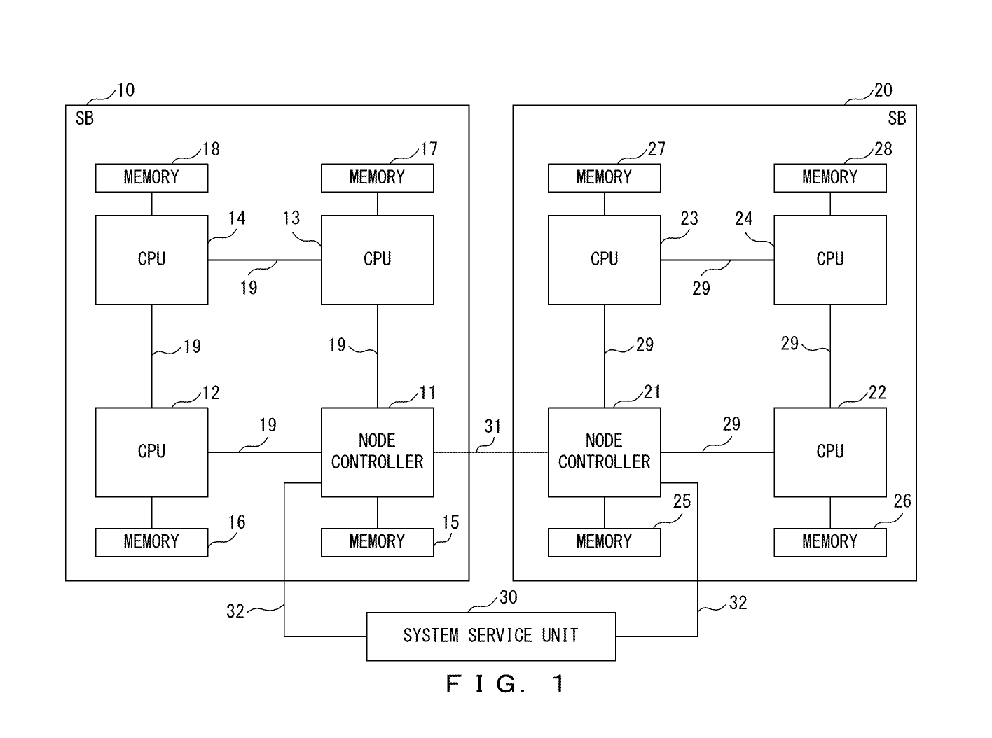

FIG. 1 illustrates an exemplary configuration of a computer system.

The computer system illustrated in FIG. 1 includes a plurality of nodes, i.e., a plurality of service boards (SBs) 10 and 20 and one system service unit 30. The number of service boards is not limited to two. The service board may be referred to as a system board.

The service board 10 includes one node controller 11 and a plurality of CPUs (or processors) 12 to 14. The node controller 11 has a memory 15 connected via a memory bus. The CPUs 12, 13 and 14 respectively have memories 16, 17 and 18 connected via memory buses.

In the example of FIG. 1, the service boards 10 and 20 are each, for example, a single mounted board. The node controllers 11 and 21, the CPUs 12 to 14, and CPUs 22 to 24 are each a single LSI. The memories 15 to 18 and memories 25 to 28 are, for example, DIMMs (Dual Inline Memory Modules).

The CPUs 12 and 13 are directly connected to the node controller 11 via system buses 19. The CPUs 12 and 13 directly transmit data to and directly receive data from the node controller 11. Meanwhile, the CPU 14 is connected to the CPUs 12 and 13 via system buses 19 and directly transmits data to and directly receives data from the CPUs 12 and 13. The CPU 14 is not directly connected to the node controller 11. The CPU 14 transmits data to and receives data from the node controller 11 via the CPU 12 or 13.

Accordingly, in the example of FIG. 1, the service board 10 includes the CPU 14, which is not connected to the node controller 11. The service board 10 also includes the CPUs 12 and 13, which are not directly connected to each other.

The node controller 11 of the service board 10 is connected via a global system bus 31 to a node controller 21 of the service board 20. The node controller 11 transmits data to and receives data from the node controller 21. In other words, the plurality of service boards 10 and 20 are connected to each other by the node controllers 11 and 21, so data is transmitted and received between the service boards 10 and 20.

The node controller 11 is connected to the system service unit 30 via a dedicated bus 32. The system service unit 30 instructs the node controller 11 to collect and output transmission data. The data that is collected will be referred to as collected data.

The node controller 11 transmits data to and receives data from the CPUs 12 and 13 within the same service board, i.e., the service board 10, and transmits data to and receives data from the node controller 21 of the service board 20, a different service board.

As an example, when the node controller 11 receives data addressed to the node controller 11 from the CPU 12, the node controller 11 stores this received data in the memory 15. When the node controller 11 receives data addressed to the CPU 13 or 12 from the CPU 12 or 13, the node controller 11 transmits this received data to the destination CPU. When the node controller 11 receives data addressed to the node controller 21 or any of the CPUs 22 to 24 from any of the CPUs 12 to 14, the node controller 11 transmits this received data to the node controller 21. Note that data from the CPU 14 is received by the node controller 11 via the CPU 12 or 13. When the node controller 11 receives data addressed to the node controller 11 from the node controller 21, the node controller 11 stores this received data in the memory 15. When the node controller 11 receives data addressed to any of the CPUs 12 to 14 from the node controller 21, the node controller 11 transmits this received data to any of the destination CPUs 12 to 14.

As described above, the node controller 11 is a communication processor, and, on behalf of the plurality of CPUs 12 to 14 and the plurality of CPUs 22 to 24, the node controller 11 performs data transmission, i.e., signal-packet transmission, between the CPUs 12 to 14 and the CPUs 22 to 24. In other words, the node controller 11 establishes a connection between the plurality of the CPUs 12 to 14 and the plurality of the CPUs 22 to 24, all of which belong to the plurality of service boards 10 to 20. Thus, the node 10, i.e., the service board 10, is regarded as being a CPU group that includes the plurality of CPUs 12 to 14, and the CPU group includes a communication processor that transmits or receives data for the CPU group. The node controller 11 does not typically include a memory, but, in the example of FIG. 1, the node controller 11 includes the memory 15.

In the example of FIG. 1, the service board 20 has a configuration that is similar to the service board 10. However, the service board 20 may have a configuration that is different from the service board 10. As an example, the number of CPUs included in the service board 10 may be different from the number of CPUs included in the service board 20.

Conventionally, a probe to observe a transmitted waveform may be put on the system bus 19 in FIG. 1. In this case, the transmitted waveform at the system bus 19 between the node controller 11 and the CPU 12 or 13 is observed.

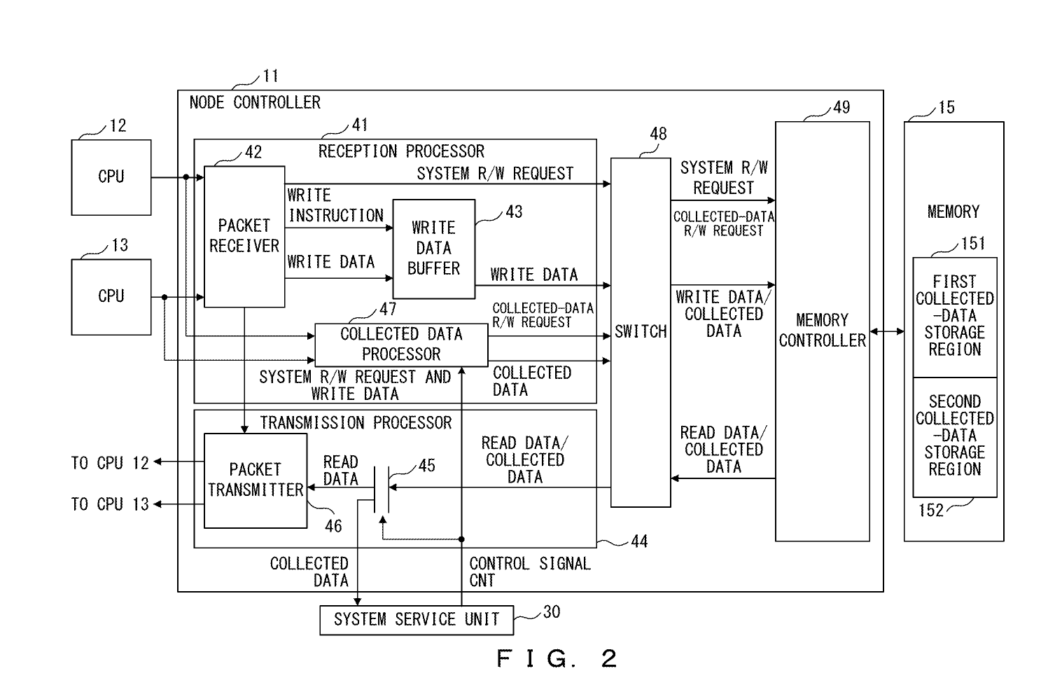

FIG. 2 illustrates an exemplary configuration of a node controller.

FIG. 2 depicts a situation in which a collected data processor 47 collects data transmitted between the node controller 11 and the CPU 12 and between the node controller 11 and the CPU 13. In other words, FIG. 2 depicts a situation in which data transmitted via the system bus 19 is collected within one service board 10. This is because the collected data processor 47 needs to collect data transmitted via the system bus 19 since a transmitted waveform on the system bus 19 is an object to be observed as described above.

The node controller 11 may collect data transmitted or received via the global system bus 31 in FIG. 1.

The node controller 11 includes a reception processor 41, a transmission processor 44, a collected data processor 47, a switch 48, and a memory controller 49. The memory 15 includes a first collected-data storage region 151 and a second collected-data storage region 152. The reception processor 41 includes a packet receiver 42 and a write data buffer 43. The transmission processor 44 includes a selection circuit 45 and a packet transmitter 46.

The reception processor 41 receives a packet transmitted from the CPU 12 or 13, and, according to the destination and the type of the packet, the reception processor 41 generates a read request or generates write data and a write request to write the write data.

In particular, upon receipt of a packet transmitted from the CPU 12 or 13, the packet receiver 42 determines the destination of the received packet. When the destination of the received packet is not the packet receiver 42, i.e., when the destination is the CPU 13 or 12, the packet receiver 42 forwards the received packet to the packet transmitter 46 in the transmission processor 44. As a result, the packet is transmitted to the CPU 13 or 12, an original destination.

When the destination of the received packet is the packet receiver 42, i.e., when the destination is the node controller 11, the packet receiver 42 further determines the type of the packet. In other words, the node controller 11 determines whether the packet requests to write data or requests to read data.

When the received packet requests to write data, the packet receiver 42 generates and transmits a write request to the switch 48. Moreover, the packet receiver 42 issues and transmits a write instruction to the write data buffer 43 together with the write data. In accordance with the write instruction, the write data buffer 43 transmits the write data to the switch 48.

When the received packet requests to read data, the packet receiver 42 generates and transmits a read request to the switch 48.

The term “system R/W request” will hereinafter be used as a generic name for the write request and the read request. The read request instructs to perform a reading process of reading data not including collected data. The write request instructs to perform a writing process of writing data not including collected data.

The collected data processor 47 collects packets received by the reception processor 41. In particular, the collected data processor 47 receives packets input to the node controller 11 without intervention of the packet receiver 42.

As a result, the collected data processor 47 may obtain the packets before these packets are received by the packet receiver 42, i.e., may obtain a signal transmitted through the system bus 19.

The collected data processor 47 generates collected data according to the collected packets and transmits the generated collected data to the switch 48. As will be described hereinafter, the collected data is obtained by sampling and performing A/D conversion to a signal included in the collected packets.

When a control signal CNT is not input from the system service unit 30, via a process that will be described hereinafter, the collected data processor 47 generates a collected-data write request, which is a request to write collected data, and transmits this collected-data write request to the switch 48.

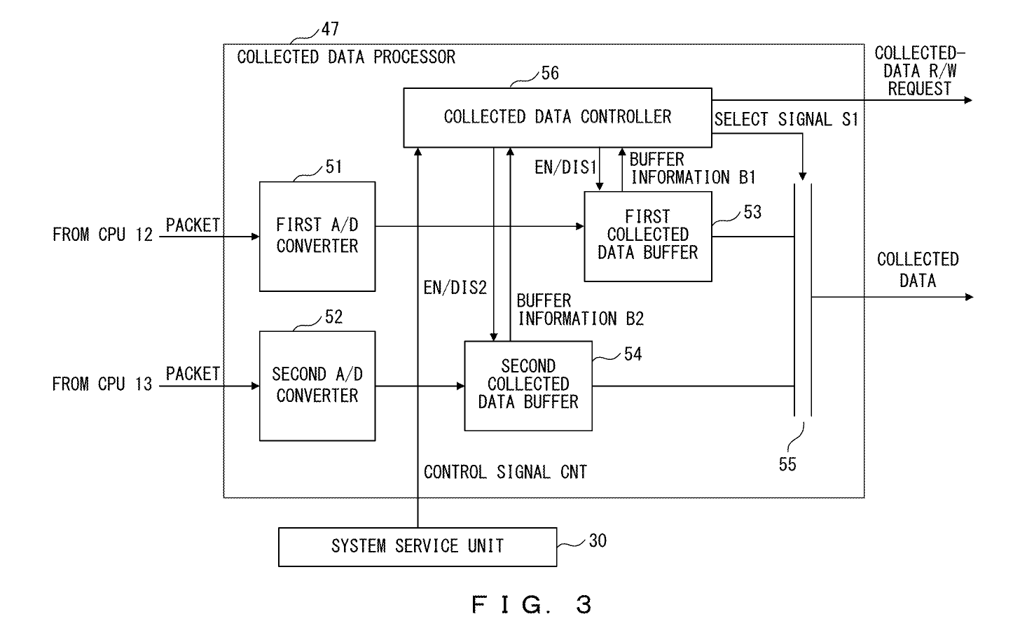

The system service unit 30 does not usually supply a control signal CNT to a collected data controller 56 in the collected data processor 47. The control signal CNT is provided when collected data is read from the memory 15. Thus, a normal system R/W request is made when the control signal CNT is not input. In other words, a normal mode is selected when the control signal CNT is not input. In the normal mode, a collected-data write request is made but a collected-data read request is not made. The collected data controller 56 will be described hereinafter with reference to FIG. 3.

When the control signal CNT is input from the system service unit 30, in accordance with the control signal CNT, the collected data processor 47 generates a collected-data read request, which is a request to read the collected data written to the memory 15, and transmits this collected-data read request to the switch 48.

A special mode is selected when the control signal CNT is not input. In the special mode, a collected-data read request is made, but a collected-data write request is not made. In other words, the system service unit 30 can designate the special mode. In the special mode, as an example, operations of the CPUs 12 to 14 are stopped, and a signal is not input from the CPUs 12 to 13 to the packet receiver 42. Before the control signal CNT is output, the system R/W request may be prohibited from being transmitted to the CPUs 12 to 14.

Meanwhile, when the control signal CNT is input from the system service unit 30 to the collected data controller 56 in the collected data processor 47, a normal system R/W request is not made but a collected-data read request is made, i.e., collected data is read from the memory 15. Accordingly, a collected-data reading mode is selected when the control signal CNT is input from the system service unit 30.

The term “collected-data R/W request” will hereinafter be used as a generic name for the collected-data write request and the collected-data read request. The collected-data read request is a request to perform a reading process of reading collected data. The collected-data write request is a request to perform a writing process of writing collected data.

The switch 48 outputs to the memory controller 49 the write data and the write request received from the packet receiver 42. The switch 48 outputs to the memory controller 49 the collected data and the collected-data write request received from the collected data processor 47. The switch 48 outputs to the memory controller 49 the read request received from the packet receiver 42. The switch 48 also outputs to the memory controller 49 the collected-data read request received from the collected data processor 47. In other words, the switch 48 switches and outputs the system R/W request and the collected-data R/W request, and switches and outputs the write data and the collected data.

In accordance with the write request received from the switch 48, the memory controller 49 writes the write data to the memory 15. The write data is written to a region designated by the write request.

In accordance with the collected-data write request received from the switch 48, the memory controller 49 writes the collected data to the memory 15. The memory controller 49 writes the collected data to storage regions 151 and 152 in the memory 15, both of which are specified in advance. The storage regions 151 and 152 are designated by the collected-data write request.

The plurality of storage regions 151 and 152 are associated with the CPUs 12 and 13 connected to the node controller 11. For example, the storage region 151 is associated with the CPU 12 and stores collected data obtained from packets received from the CPU 12. The storage region 152 is associated with the CPU 13 and stores collected data obtained from packets received from the CPU 13. As a result, it is possible to distinguish a system bus 19 through which packets that form collected data have been transmitted.

As described above, transmission waveforms on the system bus 19 can be collected without using an oscilloscope or a probe. Moreover, since there is no influence from a probe, transmission waveforms on the system bus 19 can be accurately collected. In addition, since collected data is stored in the memory 15 provided for the node controller 11, a dedicated memory to store the collected data does not need to be provided within the node controller 11. A dedicated memory within the node controller 11 would remarkably limit data capacity in view of the mounting area, but collected data having a size that is sufficient to observe the transmission waveform can be obtained using the storage regions 151 and 152 of the memory 15. Further, the chip size of the node controller 11 may be prevented from increasing due to the dedicated memory or the wiring for this memory.

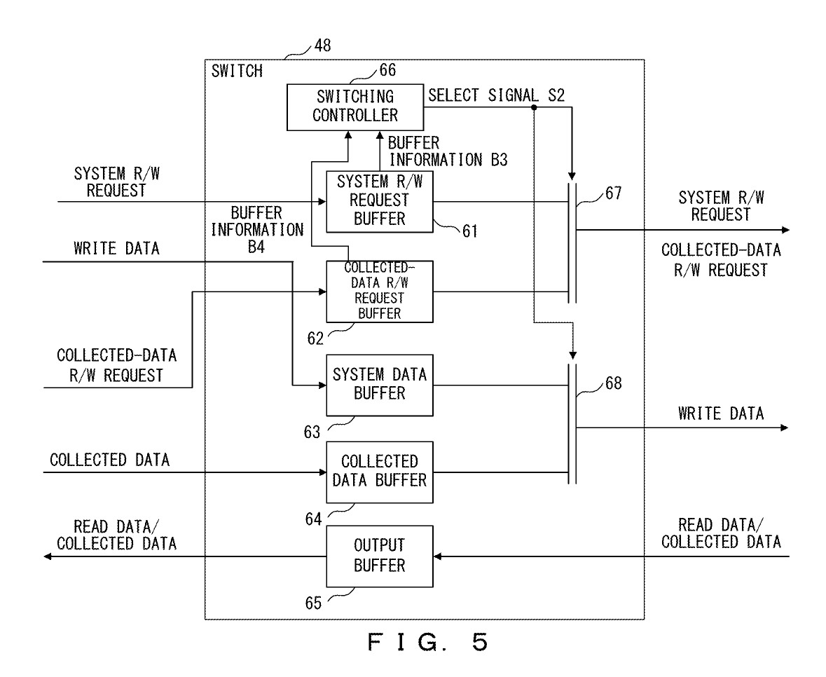

In accordance with a read request received from the switch 48, the memory controller 49 reads write data that has been written to the memory 15. The write data, which is read as read data, is read from a region of the memory 15 designated by the read request. The write data read from the memory 15 is transmitted to the selection circuit 45 via the switch 48 as read data. In FIG. 2 and FIG. 5, note that the write data read from the memory 15 is expressed as “read data”.

Meanwhile, in accordance with a collected-data read request received from the switch 48, the memory controller 49 reads collected data that has been written to the memory 15. The collected data is read from a region of the memory 15 designated by the collected-data read request. The collected data read from the memory 15 is transmitted to the selection circuit 45 via the switch 48.

In the normal mode, the transmission processor 44 transmits to the CPU 12 or 13 data read from the memory 15, and, in the collected-data reading mode, the transmission processor 44 transmits the data to the system service unit 30.

In particular, the selection circuit 45 receives, via the switch 48, read data or collected data read from the memory 15. A control signal CNT from the system service unit 30 is input to the selection circuit 45.

When the selection circuit 45 does not receive the control signal CNT from the system service unit 30, i.e., in the normal mode, the selection circuit 45 transmits received read data to the packet transmitter 46. As a result, the read data received by the selection circuit 45 is transmitted to the CPU 12 or 13. A destination CPU is a source of the read request for the read data.

Meanwhile, when the selection circuit 45 receives the control signal CNT from the system service unit 30, i.e., in the collected-data reading mode, the selection circuit 45 transmits received collected data to the system service unit 30. In other words, in accordance with the control signal CNT, the transmission processor 44 transmits the collected data read from the memory 15 to the system service unit 30, a destination specified in advance. Accordingly, the collected data may be read out of the node controller 11 and analyzed.

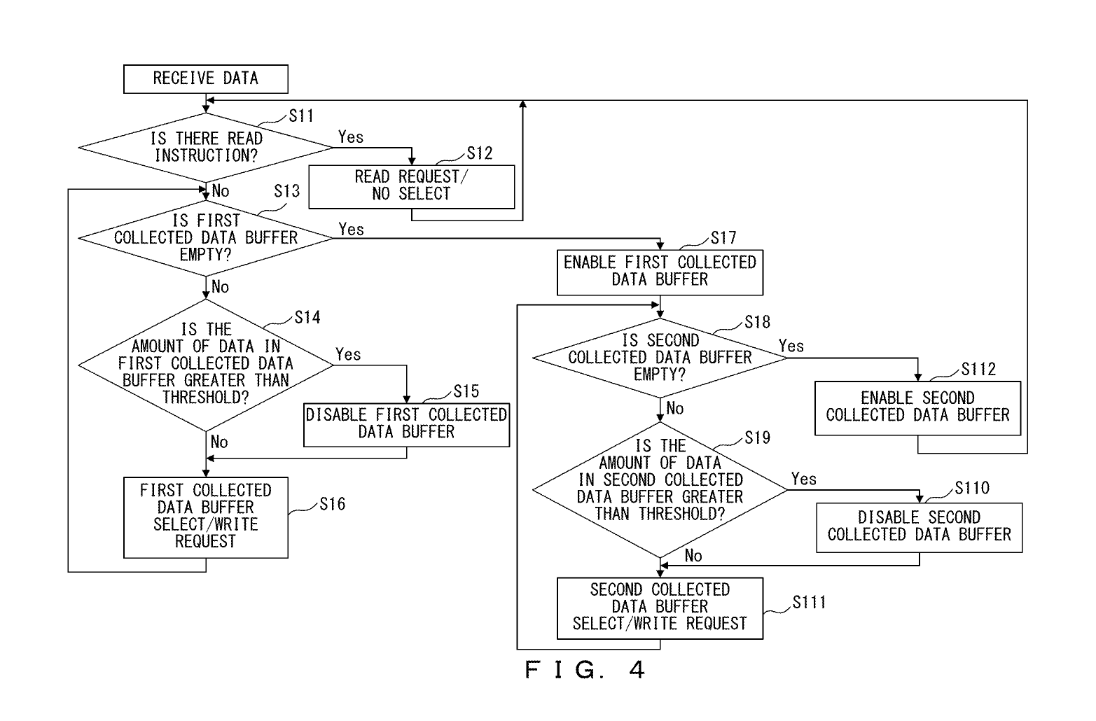

FIG. 3 illustrates an exemplary configuration of a collected data processor. FIG. 4 is a flowchart for illustrating a process for collected data process.

As illustrated in FIG. 3, the collected data processor 47 includes a first A/D (analog/digital) converter 51, a second A/D converter 52, a first collected data buffer 53, a second collected data buffer 54, a selection circuit 55, and a collected data controller 56.

The A/D converters 51 and 52 are provided in association with the CPUs 12 from which the node controller 11 receives packets. In particular, the first A/D converter 51 is associated with the CPU 12 from which the node controller 11 receives packets, and the first A/D converter 51 receives packets from the CPU 12. The first A/D converter 51 generates collected data by sampling and A/D-converting a signal included in a packet which the reception processor 41 receives from the CPU 12. The second A/D converter 52 is associated with the CPU 13 from which the node controller 11 receives packets, and the second A/D converter 52 receives packets from the CPU 13. The second A/D converter 52 generates collected data by sampling and A/D-converting a signal included in a packet which the reception processor 41 receives from the CPU 13.

Collected data is generated by sampling a voltage value (an analog value) of a signal included in a packet and converting the sampled value into a digital value. When the reception processor 41 does not receive a packet from the CPU 12 or 13, the value of collected data is approximately “0”, which is measured data that has no meaning. Meanwhile, when the reception processor 41 receives a packet from the CPU 12 or 13, collected data may be obtained from the packet irrespective of the address or the type of the packet.

The collected data buffers 53 and 54 are provided in association with corresponding A/D converters 51 and 52. In particular, the first collected data buffer 53 is associated with the first A/D converter 51 and stores collected data output from the first A/D converter 51 in accordance with an EN/DIS1 signal. The second collected data buffer 54 is associated with the second A/D converter 52 and stores collected data output from the second A/D converter 52 in accordance with an EN/DIS2 signal. The EN/DIS1 signal and the EN/DIS2 signal indicate whether or not to store collected data, and these signals are transmitted from the collected data controller 56, as will be described hereinafter.

As an example, the sizes of the collected data buffers 53 and 54 are identical with each other. The sizes of the collected data buffers 53 and 54 are determined in accordance with, for example, a cycle with which the A/D converters 51 and 52 sample a signal contained in a packet, a resolution of A/D conversion performed by the A/D converters 51 and 52, or the number of sets of collected data.

The first collected data buffer 53 transmits buffer information B1 to the collected data controller 56. Buffer information B1 indicates the amount of data stored in the first collected data buffer 53. The second collected data buffer 54 transmits buffer information B2 to the collected data controller 56. Buffer information B2 indicates the amount of data stored in the second collected data buffer 54.

In accordance with a select signal S1, the selection circuit 55 selectively outputs an output of any of the collected data buffers 53 and 54. The select signal S1 is transmitted from the collected data controller 56, as will be described hereinafter. An output of the selection circuit 55 is fed to a collected data buffer 64, which will be described hereinafter.

Using a plurality of EN/DIS signals, the collected data controller 56 controls the collected data buffers 53 and 54. In particular, the collected data controller 56 generates an EN/DIS1 signal according to the buffer information B1 from the collected data buffer 53 and feds this generated signal EN/DIS1 to the collected data buffer 53. The collected data controller 56 also generates an EN/DIS2 signal according to the buffer information B2 from the collected data buffer 54 and feds this generated signal EN/DIS2 to the collected data buffer 54.

The collected data controller 56 may generate a plurality of EN/DIS signals according to a control signal from the system service unit 30 for generating the EN/DIS signals. The collected data controller 56 may generate a plurality of EN/DIS signals at a timing specified in advance.

Enable (EN) in the EN/DIS1 signal is a signal that instructs the first collected data buffer 53 to store collected data, and, as an example, the EN is used when the service board 10 is turned on or when the first collected data buffer 53 is empty, as will be described hereinafter. Disable (DIS) of the EN/DIS1 signal is a signal that prohibits the first collected data buffer 53 from storing collected data, and, as an example, the DIS is used when the amount of collected data stored in the first collected data buffer 53 exceeds a data amount threshold, as will be described hereinafter.

Enable (EN) of the EN/DIS2 signal is a signal that instructs the second collected data buffer 54 to store collected data, and, as an example, the EN is used when the service board 10 is turned on or when the second collected data buffer 54 is empty, as will be described hereinafter. Disable (DIS) of the EN/DIS2 signal is a signal that prohibits the second collected data buffer 54 from storing collected data, and, as an example, the DIS is used when the amount of collected data stored in the second collected data buffer 54 exceeds a data amount threshold, as will be described hereinafter.

The collected data controller 56 controls the selection circuit 55. For example, the collected data controller 56 generates a select signal S1 according to the buffer information B1 and B2 from the collected data buffers 53 and 54 and feds this generated signal S1 to the selection circuit 55.

The collected data controller 56 also generates a collected-data R/W request according to a control signal CNT from the system service unit 30. The collected-data R/W request generated by the collected data controller 56 is fed to a collected-data R/W request buffer 62, which will be described hereinafter.

In particular, when the collected data controller 56 does not receive the control signal CNT from the system service unit 30, i.e., in the normal mode, the collected data controller 56 generates a collected-data write request. As a result, the collected-data write request is fed to the collected-data R/W request buffer 62, allowing collected data to be written to the memory 15.

Accordingly, during periods other than a period during which the collected data controller 56 receives the control signal CNT, the collected data controller 56 outputs a collected-data write request. The timings at which collected data is collected are not specified. The collected data controller 56 may output collected-data write requests at preset timings, and the switch 48 may execute these output requests so that collected data can be collected at specific timings.

When the collected data controller 56 receives a control signal CNT from the system service unit 30, i.e., in the collected-data reading mode, the collected data controller 56 generates a collected-data read request. As a result, the collected-data read request is input into the collected-data R/W request buffer 62 so that collected data can be read from the memory 15.

Next, a process for the collected data performed by the collected data processor in FIG. 3 will be described with reference to FIG. 4.

As described above, when the collected data controller 56 does not receive a control signal CNT from the system service unit 30, the collected data controller 56 is operated in the normal mode and generates a collected-data write request in a process that will be described hereinafter. When the collected data controller 56 receives a control signal CNT from the system service unit 30, the collected data controller 56 is operated in the collected-data reading mode and generates a collected-data read request. When a control signal CNT is output from the system service unit 30, priority is given to the reading of collected data over a system R/W request.

Meanwhile, upon receipt of a packet from the CPU 12, the first A/D converter 51 generates and outputs collected data to the first collected data buffer 53. Upon receipt of a packet from the CPU 13, the second A/D converter 52 generates and outputs collected data to the second collected data buffer 54.

In addition, upon the turning on of the power, the collected data controller 56 feds the enable (EN) of the EN/DIS1 signal and the enable (EN) of the EN/DIS2 signal to the first collected data buffer 53 and the second collected data buffer 54. Accordingly, the first collected data buffer 53 stores the collected data output from the first A/D converter 51. The second collected data buffer 54 stores the collected data output from the second A/D converter 52.

As illustrated in FIG. 4, the collected data controller 56 determines whether or not the system R/W request from the packet receiver 42 is a read request instruction or whether or not there is no instruction from the packet receiver (S11). When the system R/W request is a read request instruction or when there is no instruction from the packet receiver 42 (Yes in S11), the collected data controller 56 does not perform any process (S12) and repeats process S11. In S12, data is not collected but a read request is executed.

When the system R/W request is not a read instruction (No in S11), i.e., when the system R/W request is a write instruction, the collected data controller 56 determines whether or not the first collected data buffer 53 is empty according to the buffer information B1 of the first collected data buffer 53 (S13). The processes may be performed for the second collected data buffer 54 preferentially over the first collected data buffer 53.

As described above, the collected data controller 56 may generate a plurality of EN/DIS signals according to a control signal from the system service unit 30 for generating the EN/DIS signals, in a manner such that the processes are performed for, for example, the first collected data buffer 53 only. In this case, only collected data with respect to a packet received from the CPU 12 is collected. In this case, transmission of a signal through the system bus 19 to which the CPU 12 is connected is monitored. Moreover, the collected data with respect to the CPU 13 does not need to be stored in the second collected-data storage region 152 in the memory 15. As a result, a larger amount of collected data with respect to packets received from the CPU 12 can be stored using the second collected-data storage region 152, or the memory 15 may be effectively used by omitting the second collected-data storage region 152.

When the first collected data buffer 53 is not empty (No in S13), the collected data controller 56 determines whether or not the amount of the collected data stored in the first collected data buffer 53 is greater than a data amount threshold according to the buffer information B1 of the first collected data buffer 53 (S14). The data amount threshold may be preset from experience.

When the amount of the collected data stored in the first collected data buffer 53 is greater than the data amount threshold (Yes in S14), the collected data controller 56 feds the disable (DIS) of the EN/DIS1 signal to the first collected data buffer 53 (S15). Accordingly, from among the collected data buffers 53 and 54, the first collected data buffer 53 that stores an amount of collected data greater than the data amount threshold is prohibited from newly storing collected data. Meanwhile, when the amount of the collected data stored in the first collected data buffer 53 is not greater than the data amount threshold (No in S14), process S15 is not performed.

Then, the collected data controller 56 generates and outputs a collected-data write request. In addition, the collected data controller 56 generates and inputs, to the selection circuit 55, a select signal S1 that selects an output of the first collected data buffer 53 (S16). As a result, from among the collected data buffers 53 and 54, an output of the first collected data buffer 53 that stores an amount of collected data greater than the data amount threshold is selectively output from the selection circuit 55. Accordingly, the collected data stored in the first collected data buffer 53 is written to the first collected-data storage region 151 in the memory 15. After that, the process is returned to S13.

When the first collected data buffer 53 is empty (Yes in S13), the collected data controller 56 feds the enable (EN) of the EN/DIS1 signal to the first collected data buffer 53 (S17). Accordingly, the first collected data buffer 53 stores collected data, or when the storing of collected data has been prohibited, the first collected data buffer 53 restarts the storing of collected data.

After this, the collected data controller 56 determines whether or not the second collected data buffer 54 is empty according to the buffer information B2 of the second collected data buffer 54 (S18).

When the second collected data buffer 54 is not empty (No in S18), the collected data controller 56 further determines whether or not the amount of the collected data stored in the second collected data buffer 54 is greater than the data amount threshold according to the buffer information B2 of the second collected data buffer 54 (S19).

When the amount of the collected data stored in the second collected data buffer 54 is greater than the data amount threshold (Yes in S19), the collected data controller 56 feds the disable (DIS) of the EN/DIS2 signal to the second collected data buffer 54 (S110). Accordingly, from among the collected data buffers 53 and 54, the second collected data buffer 54 that stores an amount of collected data greater than the data amount threshold is prohibited from newly storing collected data. Meanwhile, when the amount of the collected data stored in the second collected data buffer 54 is not greater than the data amount threshold (No in S19), S110 is not performed.

Then, the collected data controller 56 generates and outputs a collected-data write request. In addition, the collected data controller 56 generates and feds, to the selection circuit 55, a select signal S1 that selects an output of the second collected data buffer 54 (S111). As a result, from among the collected data buffers 53 and 54, an output of the second collected data buffer 54 that stores an amount of collected data greater than the data amount threshold is selectively output from the selection circuit 55. Accordingly, the collected data stored in the second collected data buffer 54 is written to the second collected-data storage region 152 in the memory 15. After that, the process is returned to S18.

When the second collected data buffer 54 is empty (Yes in S18), the collected data controller 56 feds the enable (EN) of the EN/DIS2 signal to the second collected data buffer 54 (S112). Accordingly, the second collected data buffer 54 stores collected data, or when the storing of collected data has been prohibited, the second collected data buffer 54 restarts the storing of collected data. Then the process is returned to S11.

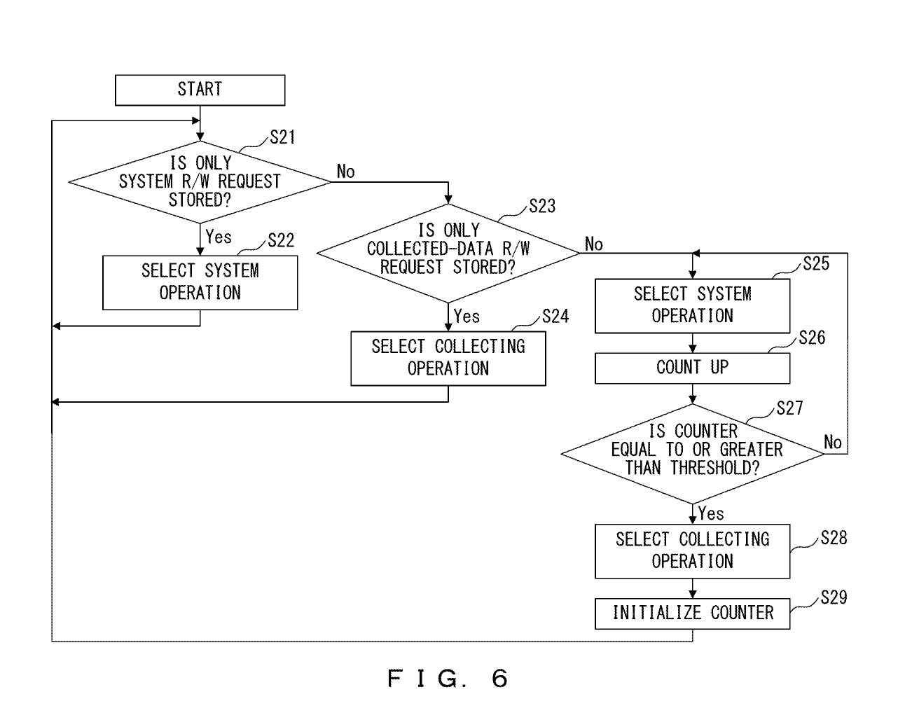

FIG. 5 illustrates an exemplary configuration of a switch. FIG. 6 is a flowchart of an operation of a switching controller.

As illustrated in FIG. 5, a switch 48 includes a system R/W request buffer 61, a collected-data R/W request buffer 62, a system data buffer 63, a collected data buffer 64, an output buffer 65, a switching controller 66, a request selection circuit 67, and a data selection circuit 68.

The system R/W request buffer 61 is a request buffer to store a write request or a read request, i.e., a system R/W request, received from the packet receiver 42. The system R/W request buffer 61 transmits buffer information B3 to the switching controller 66. Buffer information B3 indicates a system R/W request stored in the system R/W request buffer 61. The system R/W request stored in the system R/W request buffer 61 is input to the request selection circuit 67.

The collected-data R/W request buffer 62 is a collected-data request buffer to store a collected-data write request or a collected-data read request, i.e., a collected-data R/W request, received from the collected data controller 56 in the collected data processor 47. The collected-data R/W request buffer 62 transmits buffer information B4 to the switching controller 66. Buffer information B4 indicates a collected-data R/W request stored in the collected-data R/W request buffer 62. The collected-data R/W request stored in the collected-data R/W request buffer 62 is input to the request selection circuit 67.

The system data buffer 63 is a data buffer to store write data received from the write data buffer 43. The write data stored in the system data buffer 63 is input to the data selection circuit 68.

The collected data buffer 64 stores collected data received from the selection circuit 55 in the collected data processor 47. The collected data stored in the collected data buffer 64 is input to the data selection circuit 68.

The output buffer 65 is a data buffer to store write data read from the memory 15 or collected data read from the memory 15. The write data or the collected data stored in the output buffer 65 is input to the selection circuit 45.

In accordance with a select signal S2, the request selection circuit 67 selectively outputs an output of the system R/W request buffer 61 or an output of the collected-data R/W request buffer 62. As will be described hereinafter, the select signal S2 is transmitted from the switching controller 66.

In accordance with the select signal S2, the data selection circuit 68 selectively outputs an output of the system data buffer 63 or an output of the collected data buffer 64. Accordingly, when the request selection circuit 67 selects an output of the system R/W request buffer 61, the data selection circuit 68 selects an output of the system data buffer 63. When the request selection circuit 67 selects an output of the collected-data R/W request buffer 62, the data selection circuit 68 selects an output of the collected data buffer 64.

The switching controller 66 controls the request selection circuit 67. The switching controller 66 generates a select signal S2 according to the buffer information B3 from the system R/W request buffer 61 and the buffer information B4 from the collected-data R/W request buffer 62, and the switching controller 66 feds this select signal S2 to the request selection circuit 67.

The switching controller 66 also controls the data selection circuit 68. The switching controller 66 feds to the data selection circuit 68 the select signal S2 generated according to the buffer information B3 from the system R/W request buffer 61 and the buffer information B4 from the collected-data R/W request buffer 62.

Next, a switching process performed by the switch 48 illustrated in FIG. 5 will be described with reference to FIG. 6.

According to the buffer information B3 from the system R/W request buffer 61 and the buffer information B4 from the collected-data R/W request buffer 62, the switching controller 66 determines whether or not these buffers store a system R/W request only (S21).

When only a system R/W request is stored (Yes in S21), the switching controller 66 selects a system operation, i.e., selects execution of the system R/W request (S22). In other words, the switching controller 66 selects the system R/W request stored in the system R/W request buffer 61 and generates and inputs, to the request selection circuit 67 and the data selection circuit 68, a select signal S2 that selects write data stored in the system data buffer 63.

Accordingly, as an example, the request selection circuit 67 outputs a write request stored in the system R/W request buffer 61, and the data selection circuit 68 outputs write data stored in the system data buffer 63. As another example, the request selection circuit 67 outputs a read request stored in the system R/W request buffer 61. In this case, the write data read from the memory 15 is transmitted as read data to the transmission processor 44 via the output buffer 65.

S22 is performed when a system R/W request is stored in the system R/W request buffer 61 and a collected-data R/W request is not stored in the collected-data R/W request buffer 62. After S22, the process is returned to S21.

When it is not only a system R/W request that is stored (No in S21), the switching controller 66 further determines whether or not the system R/W request buffer 61 and the collected-data R/W request buffer 62 store only a collected-data R/W request according to the buffer information B3 from the system R/W request buffer 61 and the buffer information B4 from the collected-data R/W request buffer 62 (S23).

When a system R/W request is not stored and a collected-data R/W request is stored (Yes in S23), the switching controller 66 selects a collecting operation, i.e., execution of the collected-data R/W request (S24). In other words, the switching controller 66 selects the collected-data R/W request stored in the collected-data R/W request buffer 62 and generates and inputs, to the request selection circuit 67 and the data selection circuit 68, a select signal S2 that selects the collected data stored in the collected data buffer 64.

Accordingly, as an example, the request selection circuit 67 selects the collected-data write request stored in the collected-data R/W request buffer 62, and the data selection circuit 68 selects the collected data stored in the collected data buffer 64. As another example, the request selection circuit 67 outputs the collected-data read request stored in the collected-data R/W request buffer 62. In this case, the collected data read from the memory 15 is transmitted to the transmission processor 44 via the output buffer 65.

S24 is performed when a system R/W request is not stored in the system R/W request buffer 61 and a collected-data R/W request is stored in the collected-data R/W request buffer 62. After S24, the process is returned to S21.

When it is not only a collected-data R/W request is stored (No in S23), the switching controller 66 selects a system operation, i.e., selects execution of a system R/W request (S25). As a result, as described above, a write request and write data are output, or a read request is output.

S25 is performed when a system R/W request is stored in the system R/W request buffer 61 and a collected-data R/W request is stored in the collected-data R/W request buffer 62.

Then, the switching controller 66 increments a value of a counter by +1 (S26). An initial value of the counter is “0”. Moreover, the switching controller 66 determines whether or not the count value of the counter is equal to or higher than a counter threshold (S27). The counter threshold may be preset from experience. When the count value is not equal to or higher than the counter threshold (No in S27), the process is returned to S25.

When the count value is equal to or higher than the counter threshold (Yes in S27), the switching controller 66 selects a collecting operation, i.e., selects execution of a collected-data R/W request (S28). As a result, as described above, a collected-data write request and collected data are output, or a collected-data read request is output.

After this, the switching controller 66 initializes the counter (S29) and the process is returned to S21. Through steps S21 to S29, the request selection circuit 67 is controlled in such a manner that a ratio determined in advance is achieved between the number of times an output of the system R/W request buffer 61 is selected and the number of times an output of the collected-data R/W request buffer 62 is selected.

Accordingly, one collected-data R/W request can be performed every a specified number of times of system R/W requests are performed. This allows a collected-data R/W request to be performed to store collected data in the memory 15 while executing a system R/W request so as to read or write data. When a collected-data read request is stored in the collected-data R/W request buffer 62, a system R/W request is not stored in the system R/W request buffer 61. Thus, in fact, one collected-data write request is performed every time a number of times of system R/W requests are performed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A node controller comprising:
a reception processor configured to receive a packet and to generate a read request or write data and a write request for requesting to write the write data, according to a destination and a type of the packet;
a collected data processor configured to collect the packet received by the reception processor, to generate collected data according to the collected packet, and to generate a collected-data write request for requesting to write the collected data;
a switch configured to output the write data and the write request received from the reception processor or output the collected data and the collected-data write request received from the collected data processor; and
a memory controller configured to write the write data to a memory in accordance with the write request received from the switch and to write the collected data to the memory in accordance with the collected-data write request received from the switch.

2. The node controller according to claim 1, further comprising:
a transmission processor configured to transmit data read from the memory, wherein
the collected data processor generates a collected-data read request for requesting to read the collected data written to the memory in accordance with a control signal,
the switch outputs the collected-data read request received from the collected data processor to the memory controller,
the memory controller reads the write data written to the memory in accordance with a read request received from the switch and reads the collected data written to the memory in accordance with the collected-data read request received from the switch, and
the transmission processor transmits the write data read from the memory to a destination designated by the read request in accordance with the control signal, and transmits the collected data read from the memory to a destination designated by the control signal.

3. The node controller according to claim 1, wherein
the collected data processor further includes
a plurality of A/D converters configured to AD-convert a signal included in the packet received by the reception processor so as to generate the collected data,
a plurality of collected data buffers associated with the plurality of A/D converters and configured to store the collected data generated by the A/D converters,
a selection circuit configured to selectively output any of outputs of the plurality of collected data buffers, and
a collected data controller configured to control the plurality of collected data buffers and the selection circuit.

4. The node controller according to claim 3, wherein
the collected data controller prohibits a collected data buffer from among the plurality of collected data buffers that stores collected data greater than a specified value from newly storing collected data, and causes the selection circuit to selectively output an output of this collected data buffer.

5. The node controller according to claim 1, wherein
the switch further includes
a request buffer configured to store the write request or the read request,
a collected-data request buffer configured to store the collected-data write request or a collected-data read request,
a write data buffer configured to store the write data,
a collected data buffer configured to store the collected data,
a read data buffer configured to store write data read from the memory or collected data read from the memory,
a request selection circuit configured to selectively output any of an output of the request buffer and an output of the collected-data request buffer, and
a data selection circuit configured to selectively output any of an output of the write data buffer and an output of the collected data buffer.

6. The node controller according to claim 5, wherein
the switch controls the request selection circuit so as to achieve a preset ratio between the number of times an output of the request buffer is selected and the number of times an output of the collected-data request buffer is selected.

7. A method of controlling a node controller, the method comprising:
generating a read request or write data and a write request for requesting to write the write data, according to a destination and a type of a packet received by a reception processor;
collecting, by a collected data processor, the packet received by the reception processor to generate collected data according to the packet, and generating a collected-data write request for requesting to write the collected data;
outputting, by a switch, to a memory controller the write data and the write request received from the reception processor or outputting to the memory controller the collected data and the collected-data write request received from the collected data processor; and
writing, by the memory controller, the write data to the memory in accordance with the write request received from the switch, and writing the collected data to the memory in accordance with the collected-data write request received from the switch.

8. A computer system including a plurality of nodes, wherein
each of the nodes include
a node controller connected to a node controller of another node via a global system bus,
a memory connected to the node controller, and
a plurality of CPUs connected to the node controller via a system bus, wherein
the node controller includes
a reception processor configured to receive a packet and to generate a read request or write data and a write request for requesting to write the write data, according to a destination and a type of the packet;
a collected data processor configured to collect the packet received by the reception processor, to generate collected data according to the collected packet, and to generate a collected-data write request for requesting to write the collected data;
a switch configured to output the write data and the write request received from the reception processor or output the collected data and the collected-data write request received from the collected data processor; and
a memory controller configured to write the write data to the memory in accordance with the write request received from the switch and to write the collected data to the memory in accordance with the collected-data write request received from the switch.
